(19) United States
(12) Patent Application Publication
(10) Pub. No.: US 2019/0198245 A1
(43) Pub. Date: Jun. 27, 2019

(54) CERAMIC-POLYMER COMPOSITE CAPACITORS AND MANUFACTURING METHOD

(71) Applicant: SABIC GLOBAL TECHNOLOGIES B.V., Bergen op Zoom (NL)

(72) Inventors: Mark Sanner, Evansville, IN (US); Neal Pfeiffenberger, Conhohocken, PA (US)

(21) Appl. No.: 16/327,655

(22) PCT Filed: Aug. 25, 2017
(86) PCT No.: PCT/US2017/048725

§ 371 Date: Feb. 22, 2019

Related U.S. Application Data
(60) Provisional application No. 62/379,861, filed on Aug. 26, 2016.

(51) Int. Cl. H01G 4/20; C04B 35/468; C04B 35/495; C04B 35/634; B32B 18/00; H01G 4/12; H01G 4/18

(52) U.S. Cl. CPC H01G 4/206; H01G 4/30; C04B 35/495; C04B 35/634; B32B 18/00; H01G 4/12; H01G 4/186; C04B 2235/3203; C04B 2235/3256; C04B 2235/604; C04B 2235/656; C04B 2235/9607; C04B 2237/34; C04B 2237/704; C04B 35/4682

(57) ABSTRACT

Capacitors including ceramic composite materials, and associated methods are shown. In selected examples, ceramic materials for capacitor dielectrics are processed at low temperatures that permit incorporation of low temperature components, such as polymer components.

### CLAIM OF PRIORITY

This application claims the benefit of priority to U.S. Provisional Patent Application Ser. No. 62/379,861, filed on Aug. 26, 2016, which is hereby incorporated by reference herein in its entirety.

### TECHNICAL FIELD

This invention relates to ceramic composite materials, applications and products made using ceramic composite materials, and methods/manufacturing devices involving ceramic composite materials. In one example, this invention relates to ceramic composite materials that include at least one polymer integrated within a sintered microstructure.

### BACKGROUND

Sintering ceramic materials typically involves using a polymer binder to hold a ceramic powder together in a green state. The ceramic powder and polymer binder are heated to very high temperatures where the polymer binder is burned off leaving only the ceramic material behind. At the high temperatures, the grains of the ceramic powder begin to fuse together at contact points to form a sintered microstructure of ceramic material only.

Sintered ceramic composite materials are desirable due to potential combinations of material properties from both matrix and dispersed phases. However, as with the burn off of polymer binder in green state manufacture, the high temperature processing of ceramic powders in sintering makes many ceramic composite materials impossible. It is desired to be able to form sintered ceramic structures at lower temperatures that permit various composite combinations, such as ceramic and polymer composite materials.

### BRIEF DESCRIPTION OF THE DRAWINGS

FIG. 1A shows a mixture of powder particles prior to heating according to an example of the invention.

FIG. 1B shows the material of FIG. 1A after some amount of heating according to an example of the invention.

FIG. 2 shows a diagram of a composite dielectric material microstructure according to an example of the invention.

FIG. 3 shows another diagram of a composite dielectric material microstructure according to an example of the invention.

FIG. 4 shows a capacitor according to an example of the invention.

FIG. 5 shows a capacitor according to an example of the invention.

FIG. 6 shows a method of forming a capacitor according to an example of the invention.

FIG. 7a-7c shows a dielectric constant data for selected composite dielectric materials according to an example of the invention.

FIG. 8a-8c shows a dielectric loss data for selected composite dielectric materials according to an example of the invention.

FIG. 9a-9c shows a dielectric constant data for additional composite dielectric materials according to an example of the invention.

FIG. 10a-10c shows a dielectric loss data for additional composite dielectric materials according to an example of the invention.

FIG. 11a-11c shows a dielectric constant data for additional composite dielectric materials according to an example of the invention.

FIG. 12a-12c shows a dielectric loss data for additional composite dielectric materials according to an example of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “polymer” refers to a molecule having at least one repeating unit and can include copolymers.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

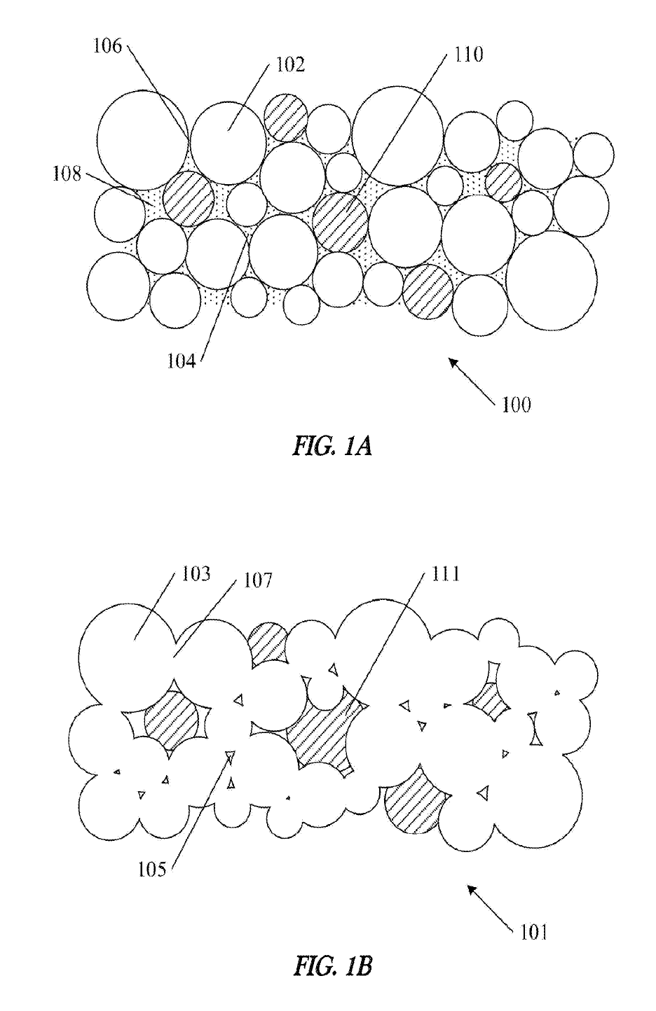

FIG. 1A shows a mixture 100 of powder particles prior to heating according to an example of the invention. The mixture 100 includes a number of ceramic particles 102 that touch each other at contact points 106. A number of voids 104 are shown between the number of ceramic particles 102, as a result of interference between particles 102 at the contact points 106. A number of secondary particles 110 are also shown as part of the mixture 100. After sintering, the number of secondary particles 110 will remain within the microstructure of the final material and become a dispersed phase within a sintered ceramic matrix phase to form a sintered ceramic composite material.

While round powder granules are used in the illustration of FIGS. 1A and 1B as an example, the invention is not so limited. Other shapes of particles for both ceramic particles 102 and secondary particles 110 may include whiskers, rods, fibrils, fibers, platelets, and other physical forms that provide contact points with each other as illustrated in FIG. 1A. Although a majority of the particles shown in the mixture 100 FIG. 1 are ceramic particles 102, and a minority are secondary particles 110, the invention is not so limited. Other examples as described below may invert these relationships. Still further examples may include mixtures 100 of more equal ratios between ceramic particles 102 and secondary particles 110. Any number of different ratios are within the scope of the invention.

In one example the ceramic particles 102 include binary ceramics, such as molybdenum oxide (MoO₃). In other examples, the ceramic particles can include binary, ternary, or quaternary compounds chosen from families of oxides, fluorides, chlorides, iodides, carbonates, phosphates, glasses, vanadates, tungstates, molybdates, tellurates, or borates. One example of a ternary ceramic particle includes K₂Mo₂O₇ Although these example ceramic families are used as examples, the list is not exhaustive. Any ceramic that is capable of cold sintering as described in the present disclosure is within the scope of the invention.

Selected examples of ceramic materials that are capable of cold sintering include, but are not limited to, BaTiO₃, Mo₂O₃, WO₃, V₂O₃, V₂O₅, ZnO, Bi₂O₃, CsBr, Li₂CO₃, CsSO₄, LiVO₃, Na₂Mo₂O₇, K₂Mo₂O₇, ZnMoO₄, Li₂MoO₄, Na₂WO₄, K₂WO₄, Gd₂(MoO₄)₃, Bi₂VO₄, AgVO₃, Na₂ZrO₃, LiFeP₂O₄, LiCoP₂O₄, KH₂PO₄, Ge(PO₄)₃, Al₂O₃, MgO, CaO, ZrO₂, ZnO—B₂O₃—SiO₂, PbO—B₂O₃—SiO₂, 3ZnO-2B₂O₃, SiO₂, 27B₂O₃-35Bi₂O₃-6SiO₂-32ZnO, Bi₂₄Si₂O₄₀, BiVO₄, Mg₃(VO₄)₂, Ba₂V₂O₇, Sr₂V₂O₇, Ca₂V₂O₇, Mg₂V₂O₇, Zn₂V₂O₇, Ba₃TiV₄O₁₅, Ba₃ZrV₄O₁₅, NaCa₂Mg₂V₃O₁₂, LiMg₄V₃O₁₂, Ca₅Zn₄(VO₄)₆, LiMgVO₄, LiZnVO₄, BaV₂O₆, Ba₃V₄O₁₃, Na₂BiMg₂V₃O₁₂, CaV₂O₆, Li₂WO₄, LiBiW₂O₈, Li₂Mn₂W₃O₁₂, Li₂Zn₂W₃O₁₂, PbO—WO₃, Bi₂O₃-4MoO₃, Bi₂Mo₃O₁₂, Bi₂O-2.2MoO₃, Bi₂Mo₂O₉, Bi₂MoO₆, 1.3Bi₂O₃—MoO₃, 3Bi₂O₃-2MoO₃, 7Bi₂O₃—MoO₃, Li₂Mo₄O₁₃, Li₃BiMo₃O₁₂, Li₈Bi₂Mo₇O₂₈, Li₂O—Bi₂O₃—MoO₃, Na₂MoO₄, Na₆MoO₁₁O₃₆, TiTe₃O₈, TiTeO₃, CaTe₂O₅, SeTe₂O₅, BaO—TeO₂, BaTeO₃, Ba₂TeO₅, BaTe₄O₉, Li₃AlB₂O₆, Bi₆B₁₀O₂₄, Bi₄B₂O₉. Although individual ceramic materials are listed, the disclosure is not so limited. In selected examples, the ceramic component can include combinations of more than one ceramic material, including, but not limited to, the ceramic materials listed above.

In one example, a ceramic material used in a cold sintering operation described in the present disclosure may possess some degree of piezoelectric behavior. In one example, a ceramic material used in a cold sintering operation described in the present disclosure may possess some degree of ferroelectric behavior. One example of such a material may include, but is not limited to, BaTiO₃, as included in the non-limiting list of examples above.

In one example, the secondary particles 110 include polymer particles. In one example, a polymer may be otherwise introduced to the mixture 100, for example at a flowable temperature, or as a resin that is later polymerized or cured.

In one example of polymer particles, the polymer 110 may include a thermoplastic polymer, such as polypropylene. In one example of polymer particles, the polymer 110 may include a thermoset polymer, such as an epoxy or the like. In one example of polymer particles, the polymer 110 may include an amorphous polymer. In one example of polymer particles, the polymer 110 may include a semi-crystalline polymer. In one example of polymer particles, the polymer 110 may include a blend, such as a miscible or immiscible blend. In one example of polymer particles, the polymer 110 may include a homopolymer. In one example of polymer particles, the polymer 110 may include a co-polymer, such as a random, or block co-polymer. In one example of polymer particles, the polymer 110 may include a branched polymer. In one example of polymer particles, the polymer 110 may include a cross-linked polymer. In one example of polymer particles, the polymer 110 may include an ionic or non-ionic polymer.

Some specific examples of acceptable polymers include, but are not limited to, polyethylene, Polyester, acrylonitrile butadiene styrene (ABS), Polycarbonate (PC), Polyphenylene oxide (PPO), Polybutylene terephthalate (PBT), isophthalate terephthalate (ITR), Nylon, HTN, polyphenyl sulfide (PPS), liquid crystal polymer (LCP), Polyaryletherketone (PAEK), polyether ether ketone (PEEK), Polyetherimide (PEI), Polyimide (PI), Fluoropolymers, PES, Polysulfone (PSU), PPSU, SRP (Paramax™), PAI (Torlon™), and blends thereof.

In one example, the mixture 100 may include one or more resins or oligomers that may be polymerized within a mold, such as an injection mold, or other tooling surface along with other components of the mixture 100. In one example, the resin is flowable. In one example, a flowable resin can form any suitable proportion of the mixture 100 composition, such as about 50 wt % to about 100 wt %, about 60 wt % to about 95 wt %, or about 50 wt % or less, or less than, equal to, or greater than about 60 wt %, 62, 64, 66, 68, 70, 72, 74, 76, 78, 80, 82, 84, 86, 88, 90, 91, 92, 93, 94, 95, 96, 97, 98, 99, 99.9, 99.99, or about 99.999 wt % or more. One or more curable resins may be included within a flowable resin. The one or more curable resins in the flowable resin can be any one or more curable resins, such as an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). The flowable resin composition can include polycarbonate (PC), acrylonitrile butadiene styrene (ABS), polybutylene terephthalate (PBT), polyethylene terephthalate (PET), polyetherimide (PEI), poly(p-phenylene oxide) (PPO), polyamide (PA), polyphenylene sulfide (PPS), polyethylene (PE) (e.g., ultra high molecular weight polyethylene (UHMWPE), ultra low molecular weight polyethylene (ULMWPE), high molecular weight polyethylene (HMWPE), high density polyethylene (HDPE), high density cross-linked polyethylene (HDXLPE), cross-linked polyethylene (PEX or XLPE), medium density polyethylene (MDPE), low density polyethylene (LDPE), linear low density polyethylene (LLDPE) and very low density polyethylene (VLDPE)), polypropylene (PP), or a combination thereof. The flowable resin can be polycarbonate, polyacrylamide, or a combination thereof.

In various embodiments, the flowable resin composition includes a filler. The flowable resin can include one filler or more than one filler. The one or more fillers can form about 0.001 wt % to about 50 wt % of the flowable resin composition, or about 0.01 wt % to about 30 wt %, or about 0.001 wt % or less, or about 0.01 wt %, 0.1, 1, 2, 3, 4, 5, 10, 15, 20, 25, 30, 35, 40, 45 wt %, or about 50 wt % or more. The filler can be homogeneously distributed in the flowable resin composition. The filler can be fibrous or particulate. The filler can be aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (atmospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds such as barium titanate, barium ferrite, barium sulfate, heavy spar, or the like; metals and metal oxides such as particulate or fibrous aluminum, bronze, zinc, copper and nickel, or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as kenaf, cellulose, cotton, sisal, jute, flax, starch, corn flour, lignin, ramie, rattan, agave, bamboo, hemp, ground nut shells, corn, coconut (coir), rice grain husks or the like; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as fillers such as mica, clay, feldspar, flue dust, fillite, quartz, quartzite, perlite, Tripoli, diatomaceous earth, carbon black, or the like, or combinations including at least one of the foregoing fillers. The filler can be talc, kenaf fiber, or combinations thereof. The filler can be coated with a layer of metallic material to facilitate conductivity, or surface treated with silanes, siloxanes, or a combination of silanes and siloxanes to improved adhesion and dispersion with the flowable resin composition. The filler can be selected from carbon fibers, a mineral fillers, or combinations thereof. The filler can be selected from mica, talc, clay, wollastonite, zinc sulfide, zinc oxide, carbon fibers, glass fibers, ceramic-coated graphite, titanium dioxide, or combinations thereof.

In one example, the polymer phase in the mixture 100 functions as a self-healing component of a dielectric in a capacitor as described in examples below. In one example, a polymer used for secondary particles 110 includes a polymer having a low ratio of carbon to a sum of oxygen and hydrogen (C/(O+H)). In one example, the ratio is less than 2.0. In one example the ratio is less than 1.5. In one example the ratio is between 2.0 and 1.5. In one example, the ratio is between 1.5 and 0.5. In one example the ratio is between 2.0 and 0.5. Polypropylene is one example of a polymer having a desirable ratio of 0.5.

In one example, a low ratio of carbon to a sum of oxygen and hydrogen indicates a polymer material with a low propensity to char when exposed to heat, such as in electric arcing. In some failure modes of capacitors, an arc will form between electrodes in the capacitor across the dielectric that separates the electrodes. One cause of such arcing may include a fracture in the dielectric material, or an undesirably thin region of dielectric. When an arc occurs, the dielectric material may char as it is burned, leaving a carbon deposit behind. A char, or carbon deposit may be sufficiently conductive, and provide a pathway for electricity to flow between the electrodes. In such a scenario, the capacitor may be considered to have failed in a short circuit condition if the failure spot cannot isolate itself from the rest of the circuit. Short circuit conditions may cause other undesirable effects such as allowing continued arcing, explosions, or further damaging other components coupled to the capacitor. It is desirable to have a configuration where if a failure were to occur, such a failure would fail “open” and isolate itself from the rest of the circuit.

In capacitor configurations where a polymer is used having a low ratio of carbon to a sum of oxygen and hydrogen, a char will be reduced or eliminated due to the low carbon content. In configurations where char is eliminated or reduced, the capacitor will have a propensity to fail “open.” In the present disclosure, a polymer that contributes to “failing open” in a dielectric of a capacitor is described as a self-healing polymer.

It is desirable to combine properties such as a high dielectric constant of a ceramic material with polymer properties such as flexibility/durability, low loss, high breakdown strength, and “self-healing” in a capacitor. Cold sintering technology as described in the present disclosure provides a manufacturing method that can accomplish this combination.

In one example the mixture 100 includes more than one type of secondary particle 110. For example, the secondary particles 110 may include multiple types of polymer particles or polymer particles and other dielectric materials.

FIG. 1A further shows an activation solvent 108 that is present, at least partially within the microstructure of the mixture 100. In one example, the activation solvent 108 includes water. Various forms of water and/or water application that may be introduced include liquid water, atomized or sprayed water, water vapor, etc. In one example, the activation solvent 108 includes an alcohol. Other examples include a mixture of different liquids or gasses to form the activation solvent 108. On of ordinary skill in the art, having the benefit of the present disclosure, will recognize that a choice of activation solvent 108 will depend on the choice of ceramic particles 102 and a choice of secondary particles 110. An effective activation solvent 108 will be capable of activating low temperature diffusion and/or material transport at the contact points 10 between ceramic particles 102. The effective activation solvent 108 will also not adversely affect material properties of the secondary particles 110. For example, an effective activation solvent 108 will not react with the secondary particles 110 in such a way as to make the secondary particles 110 volatile below a sintering or activation temperature of the ceramic particles 102.

FIG. 1B shows a composite material 101 formed after processing the mixture 100 from FIG. 1A. The microstructure shown in FIG. 1B illustrates a sintered or partially sintered microstructure. Material at contact points 106 shown in FIG. 1A have migrated to form joined regions 107 that connect sintered regions 103 that were formerly separate ceramic particles 102 prior to sintering. In one example, the activation solvent 108 provides a mechanism to move material from the ceramic particles 102 to the joined regions 107 at lower temperatures than would be possible without the activation solvent 108. In one example, the activation solvent 108 reduces a temperature required for sintering low enough that secondary particles 110 including polymer will not vaporize during sintering, and will remain within a final microstructure, as shown in FIG. 1B. Other materials apart from polymers that require a low sintering temperature may also remain as a result of low temperature sintering.

After sintering, the microstructure of FIG. 1B is a composite material 101 that includes sintered regions 103 and joined regions 107 as a substantially continuous matrix phase. At least some of the secondary particles 110 remain behind and form a dispersed phase 111 within remaining pores 105 of the composite material 101. As noted above, as a result of low temperature sintering, at least a portion of the secondary particles 110, such as polymer particles, are not vaporized, and remain within the microstructure.

In the example shown in FIG. 1B, the ceramic matrix phase includes a degree of closed cell porosity. In other words, after sintering, a number of remaining pores 105 are completely surrounded by ceramic matrix phase, and are no longer accessible from outside the microstructure. Any remaining secondary particles 110, such as polymer particles, can only be present within closed cell pores because they were located within the mixture 100 during sintering, and remained present as a result of a sintering temperature below vaporization. It is not possible to introduce a dispersed phase material to an interior of a closed cell pore after sintering.

In one example, polymer secondary particles 110 are raised to a temperature during sintering that exceeds a glass transition temperature (T_{g}) of the polymer but does not exceed a volatilization temperature of the polymer. In one example, polymer secondary particles 110 are raised to a temperature during sintering that exceeds a melting temperature (Tₘ) of the polymer but does not exceed a volatilization temperature of the polymer. It may be desirable for the polymer secondary particles 110 to flow within the remaining pores 105 and to fill the space during sintering at a pressure and temperature which facilitates the flow behavior, a larger contact area between the dispersed phase 111 and the surrounding ceramic matrix may be provided in such a configuration. In one example, sufficient material transport may be accomplished at temperatures below T_{g} and Tₘ. Advantages of increased contact area may include improved mechanical properties, such as increased toughness, improved fracture strength, and/or more desirable failure modes, such as an object cracking but not falling apart.

In one example, a combination of ceramic material and polymer secondary particles 110 are chosen to enhance properties of the composite material 101. For example, a low surface energy between the two phases (ceramic and polymer) will lead to a more continuous surface coverage at interfaces between the ceramic phase and the polymer phase. This may lead to improved mechanical properties of the composite material 101. More continuous surface coverage at interfaces between the ceramic phase and the polymer phase may also lead to improved electrical performance, such as higher improved dielectric loss or improved dielectric constant in a device such as a capacitor. In one example, a more continuous surface coverage at interfaces between the ceramic phase and the polymer phase may lead to more reliable operation of the self-healing capabilities of the polymer phase as a result of a more continuous polymer network within the composite material 101.

Other properties of a ceramic-polymer system that may be specifically chosen for improved devices include, but are not limited to, low reactivity between the ceramic and the polymer, and high adhesion at an interface between the ceramic and the polymer.

One of ordinary skill in the art, having the benefit of the present disclosure, will recognize that a sufficient activation temperature and pressure will depend on a number of factors, such as the choice of ceramic material, the choice of activating solvent, and pH of the activating solvent. One non-limiting examples includes use of water as an activating solvent, and a temperature in excess of 100° C. to activate the system.

FIG. 1B illustrates at least some degree of closed cell porosity, and a dispersed phase 111, such as a polymer dispersed phase, within at least some of the closed cells of the sintered microstructure. Because the dispersed phase 111 results primarily from the original secondary particles 110, materials of the dispersed phase 111 are substantially similar or identical to the materials of the secondary particles 110 as described above.

In other examples, closed cell porosity may not be present, however, a cold sintered microstructure will be physically observable, and distinguishable over traditional high temperature sintering. In one example, X-ray diffraction can be used to detect crystal structure. High temperature sintering may lead to crystal structure changes in the microstructure. The level of uniformity of these changes may not be similar in a cold sintered microstructure due to it being a less energy intensive process.

In another example, elemental analysis can be used to detect a presence or absence of compounds such as hydroxides and carbonates. In a high temperature sintering process, these compounds will be burned off, and not be found in the microstructure. In cold sintered structures, because temperatures during sintering will not have reached a high enough point to burn off such compounds, compounds such as hydroxides and carbonates may still be present, and detectable, indicating that the sintered microstructure was formed using cold sintering techniques.

In another example an amount of crystallinity can be measured. In a high temperature sintering process, the ceramic components may become more fully crystalline that in a cold sintering process.

FIG. 2 shows a microstructure 200 of a cold sintered material according to one example. A cold sintered first phase 204 is shown having a number of sintered grains 206 and grain boundaries 207. A polymer second phase 202 is also shown within the microstructure 200. In the example of FIG. 2, the cold sintered first phase 204 is the matrix phase, and the polymer second phase 202 is the dispersed phase. In one example, the cold sintered first phase 204 includes ceramic materials as described in examples above. In one example, the polymer second phase 202 includes polymer materials as described in examples above, for example as relating to secondary particles.

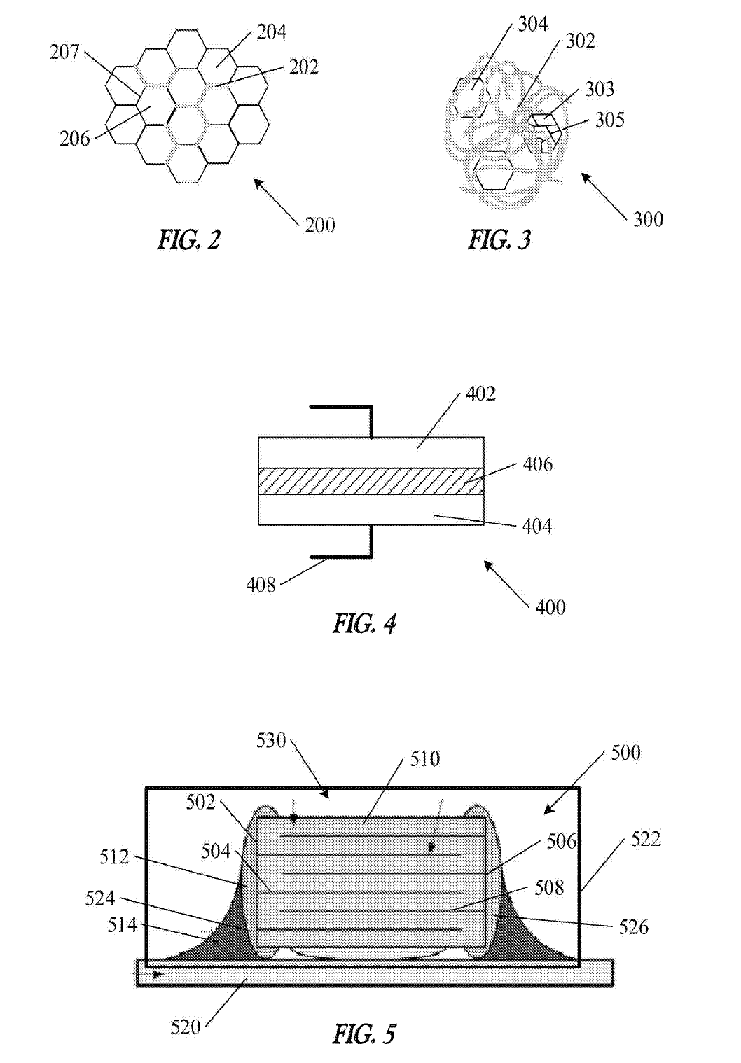

FIG. 3 shows a microstructure 300 of a cold sintered material according to one example. In the example of FIG. 3, cold sintered first phase 304 is shown. The cold sintered first phase 304 may include a number of sintered grains 303 and grain boundaries 305. FIG. 3 further shows a polymer second phase 302. In the example of FIG. 3, the cold sintered first phase 304 is the dispersed phase, and the polymer second phase 302 is the matrix phase. In one example, the cold sintered first phase 304 includes ceramic materials as described in examples above. In one example, the polymer second phase 302 includes polymer materials as described in examples above, for example as relating to secondary particles.

FIG. 4 shows a block diagram of a capacitor 400. A first electrode 402 and a second electrode 404 is shown. A composite dielectric material 406 is located between the first electrode 402 and the second electrode 404. Circuitry 408 is shown coupling the capacitor 400 to other components in an electronic device. In one example, the composite dielectric material 406 includes a cold sintered first phase and a polymer second phase. In one example the cold sintered first phase is the dispersed phase, and the polymer second phase is the matrix phase. In one example the cold sintered first phase is the matrix phase, and the polymer second phase is the dispersed phase. In other examples, a ratio of cold sintered first phase to polymer second phase may be such that neither phase is matrix or dispersed, and the microstructure is more homogenous. Any combination of cold sintered first phase and polymer second phase is within the scope of the invention.

Although a flat plate structure is shown for illustration purposes in FIG. 4, the invention is not so limited. One of ordinary skill in the art, having the benefit of the present disclosure, will recognize that other configurations such as rolled, curved, cylindrical or other complex shapes are within the scope of the invention.

In one example, the composite dielectric material 406 includes a polymer with a low ratio of carbon to a sum of oxygen and hydrogen (C/(O+H)). As described above, if the capacitor 400 were to fracture or otherwise fail across the composite dielectric material 406, the presence of a polymer second phase with a low ratio of carbon to a sum of oxygen and hydrogen will be more likely to fail open.

In one example, a coefficient of thermal expansion (CTE) of a composite dielectric material as described in the present disclosure may be modified by selecting respective amounts of a cold sintered first phase component and a self-healing polymer second phase component. Selected example composite dielectric materials were tested to determine their CTEs.

In one example, the CTE for cold-sintered hybrid materials was measured using a TA instruments thermal mechanical analyzer TMA Q400 and the data was analyzed using Universal Analysis V4.5A from TA instruments.

Samples were re-shaped to form 13 mm round diameter, 2 mm thickness pellets to fit the TMA Q400 equipment. The sample, once placed in the TMA Q400, was heated to 150° C. (@20° C./min) at which point the moisture and stress was relieved and then cooled to −80° C. (@20° C./min) to start the actual coefficient of thermal expansion measurement. The sample was heated from −80° C. to 150° C. at 5° C. per minute at which the displacement is measured over temperature.

The measurement data was then loaded into the analysis software and the coefficient of thermal expansion was calculated using the Alpha x1-x2 method. The method measured the dimension change from temperature T1 to temperature T2 and transforms the dimension change to a coefficient of thermal expansion value with the following equation:

$$CTE ( μm / ( m * ° C . ) ) = \frac{Δ L}{Δ T * L 0}$$

Where:

ΔL=change in length (μm)

ΔT=change in temperature (° C.)

L0=sample length (m)

The coefficient of thermal expansion of three polymers, including polyether imide (PEI), polystyrene (PS) and polyester, each in LiMn₂O₄(LMO) cold sintered samples, in varying levels, were tested with the TMA Q400. The results can be found in Table 1 below.

TABLE 1
coefficient of thermal expansion of LMO/PEI, LMO/PS
and LMO/polyester cold sintered composites

| | CTE(μm/(m [symbol] K)) | | |
|---|---|---|---|
| | −40° C. | 23° C. | −45° C. |
| Sample | to 40° C. | to 80° C. | to 125° C. |
| Neat LMO | 11.6 | 13.1 | 13 |
| LMO/20 vol % PEI | 14.5 | 16.9 | 15.3 |
| LMO/40 vol % PEI | 19.9 | 22.4 | 22.1 |
| [symbol] | 28.4 | 31.9 | 30.7 |
| LMO/80 vol % PEI | 36.1 | 43.1 | 42.1 |
| 100% PEI (datasheet value −20° | 54 | 54 | 54 |
| C. to 150° C.) | | | |
| LMO/5 wt % (13. [symbol] vol %) | 12 | 14.3 | NA |
| Polyestyrene powder | | | |
| LMO/10 wt % (22. [symbol] vol %) | 15.9 | 17.6 | 16.9 |
| Polyester powder | | | |

[symbol]

indicates data missing or illegible when filed

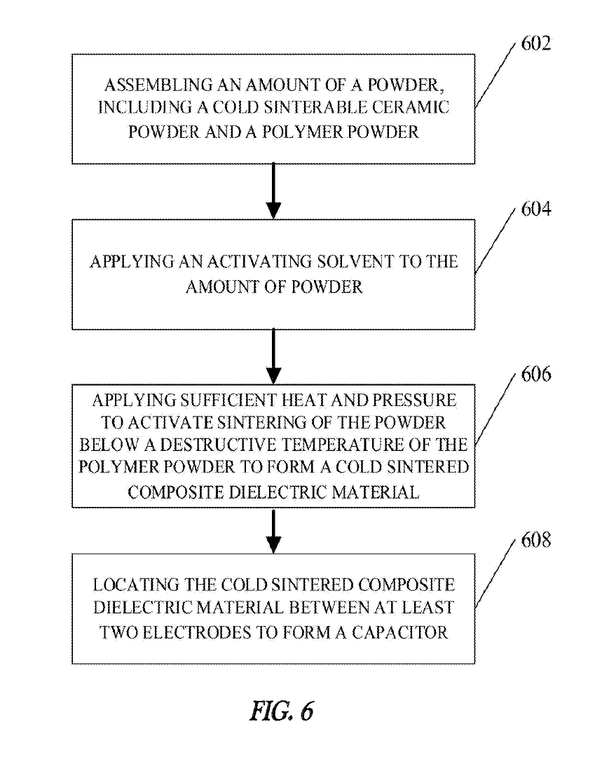

FIG. 5 shows a multilayer capacitor 500 according to one example. A first electrode 502 and a second electrode 506 is shown. A composite dielectric material 510 is located between the first electrode 502 and the second electrode 506. Similar to FIG. 4, described above, in one example, the composite dielectric material 510 includes a cold sintered first phase and a polymer second phase. In one example the cold sintered first phase is the dispersed phase, and the polymer second phase is the matrix phase. In one example the cold sintered first phase is the matrix phase, and the polymer second phase is the dispersed phase. In other examples, a ratio of cold sintered first phase to polymer second phase may be such that neither phase is matrix or dispersed, and the microstructure is more homogenous. Any combination of cold sintered first phase and polymer second phase is within the scope of the invention.

In one example, the composite dielectric material 510 includes a self-healing polymer. In one example, the composite dielectric material 510 includes a polymer with a low ratio of carbon to a sum of oxygen and hydrogen (C/(O+H)). As described above, if the capacitor 500 were to fracture or otherwise fail across the composite dielectric material 510, the presence of a polymer second phase with a low ratio of carbon to a sum of oxygen and hydrogen will be more likely to fail open.

In one example, the first electrode 502 includes a number of multilayer plates 504. In one example, the second electrode 506 includes a number of multilayer plates 508. In the example shown in FIG. 5, the multilayer plates 504, 508 are at least partially interleaved with one another. In one example, the composite dielectric material 510 thickness is approximately 0.5 microns per layer, although the invention is not so limited.

In the example of FIG. 5, a metallization 512 is included over a portion of the first electrode 502 and the second electrode 506. In one example, the metallization 512 provides a first end connection 524 and a second end connection 526. The capacitor 500 is shown mounted to a circuit board 520, using solder 514, for example.

In one example, an encapsulant 522 such as a hermetic seal encapsulant is further included surrounding the capacitor 500. In one example, the encapsulant 522 includes epoxy. In selected applications, such as medical device applications, it may be desirable to isolate the capacitor 500 from the surrounding environment using an encapsulant 522. In other examples, an encapsulant may substantially isolate components of the capacitor 500 from exposure to moisture, which may otherwise adversely affect properties of components. In one example, moisture may affect dielectric properties of a polymer component of a composite dielectric as shown in the present disclosure. The use of an encapsulant may prevent adverse effects from moisture exposure.

In the example shown in FIG. 5, the first end connection 524 and second end connection 526 are spaced apart leaving a planar stack 530 formed by the multilayer plates 504, multilayer plates 508 and composite dielectric material 510. The planar stack 530 is suspended between the first end connection 524 and the second end connection 526, and is allowed to flex. In one example, the composite dielectric material 510 includes a polymer second phase component that lowers a modulus of elasticity of the composite dielectric material 510. It is advantageous for a capacitor 500 to have increased flexibility. If the circuit board 520 flexes during manufacture, or use of the device, it is desirable that the composite dielectric material 510 will flex, and not fracture.

FIG. 6 shows a method of forming a capacitor according to one example. In operation 602, an amount of a powder is assembled. The amount of powder includes a cold sinterable ceramic powder and a polymer powder. In operation 604, an activating solvent is applied to the amount of powder. In operation 606, sufficient heat and pressure are applied to activate sintering of the powder below a destructive temperature of the polymer powder to form a cold sintered composite dielectric material. In operation 608, the cold sintered composite dielectric material is located between at least two electrodes to form a capacitor.

In one example, the cold sintered composite dielectric material is formed while in contact with the at least two electrodes as a unit. In other examples, the cold sintered composite dielectric is formed separately, and later combined with electrodes to form the capacitor. In one example, applying an activating solvent to the amount of powder includes applying water to the amount of powder. In one example, applying an activating solvent to the amount of powder includes applying a solvent including alcohol to the amount of powder.

In one example, as a result of the ability to form a composite dielectric at low temperatures using cold sintering techniques, a variety of metal choices may be used that were previously unavailable. For example, when concurrently forming a capacitor dielectric with the electrodes using high temperature ceramic sintering techniques, only high temperature metals such as palladium, nickel or platinum may be used for the electrodes. Using methods of forming as described in the present disclosure, lower temperature metals may be used because they will not be damaged when cold sintering techniques are used. For example, metals with improved conduction properties such as aluminum or copper may be used in place of refractory metals to concurrently form a capacitor dielectric with the electrodes using methods of the present invention.

A capacitor with lower temperature electrodes formed concurrently with a composite dielectric will be physically detectable after manufacture. For example, an interface between the electrodes and the dielectric may include detectable intermetallic compounds formed during manufacture that will indicate that the electrodes were formed in contact with the dielectric. Other detectable features such as grain growth/grain structure in the electrodes will indicate if the electrodes were present and in contact with the dielectric material during formation and/or sintering of the composite dielectric. In other examples, electrodes may be formed separately, for example by sputtering, or physical vapor deposition after formation of the dielectric material.

In one example, polymer resin, monomer, oligomer, or similar precursor polymer molecules may be introduced to an amount of cold sinterable ceramic powder and subjected to heat and/or pressure at the same time as the cold sinterable ceramic powder. In one example a first temperature and pressure may be used to activate the cold sintering process, while a second temperature and pressure may be used to activate polymerization and/or curing of the polymer precursor molecules. In other examples, a single temperature and pressure may be used to activate polymerization and/or curing of the polymer precursor molecules and to activate the cold sintering process at the same time.

In one example, applying pressure may include compressing the flowable resin composition in the mold to any suitable pressure, such as about 1 MPa to about 5,000 MPa, about 20 MPa to about 80 MPa, or such as about 0.1 MPa or less, or less than, equal to, or greater than 0.5 MPa, 1, 2, 3, 4, 5, 10, 15, 20, 25, 30, 35, 40, 45, 50, 55, 60, 65, 70, 75, 80, 90, 100, 125, 150, 175, 200, 250, 300, 400, 500, 750, 1,000, 1,500, 2,000, 2,000, 3,000, 4,000, or about 5,000 MPa or more. The method can include holding a mold cavity in a compressed state (with the resin composition and the cold sinterable ceramic powder) for a predetermined time period, such as about 0.1 s to about 10 h, about 1 s to about 5 h, or about 5 s to about 1 min, or about 0.1 s or less, or about 0.5 s, 1, 2, 3, 4, 5, 10, 20, 30, 45 s, 1 min, 2, 3, 4, 5, 10, 15, 20, 30, 45 min, 1 h, 2, 3, 4, or about 5 h or more.

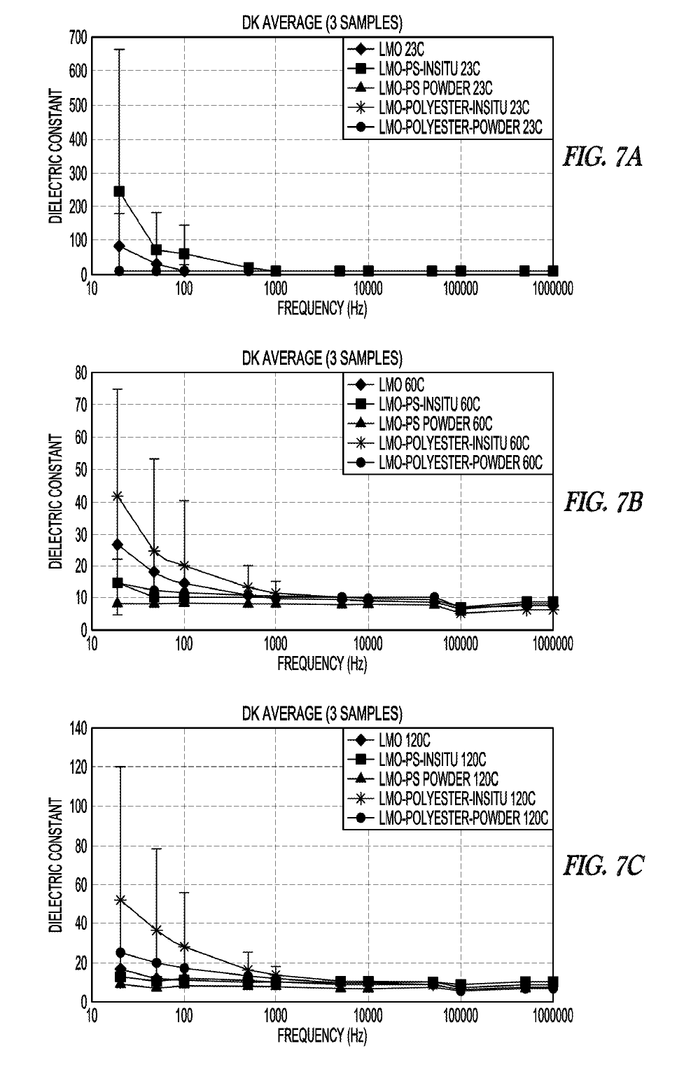

FIGS. 7-12 illustrate electrical test data of dielectric properties of selected example composite dielectric materials according to the present disclosure. While selected examples of material selection are shown, the invention is not so limited.

For testing, sample thickness was measured using a Heidenhain Metro gauge accurate to ±0.2 μm. Three locations in a 13 mm area were chosen for film thicknesses measurement prior to metallization and their average was used for the dielectric constant calculations. For dielectric constant and loss measurements, Metalon® HPS-FG32 silver ink was deposited on each sample after drying in a vacuum oven at 120° C. for 2 hours using a 13 mm diameter circular mask. The silver ink coated samples were then cured at 120° C. for 2 hours. An Agilent E4980A Precision LCR Meter synced with a Tenney humidity and temperature chamber was used to measure dielectric constant and dielectric loss as a function of frequency at 23° C., 60° C., 120° C. The connection from the LCR meter was made with a Keysight 16048A test lead kit soldered to two spring probes.

FIGS. 7a-7c show dielectric constant data for lithium molybdate (LMO) with polystyrene (PS) and polyester at 23, 60, and 120 degrees C. respectively.

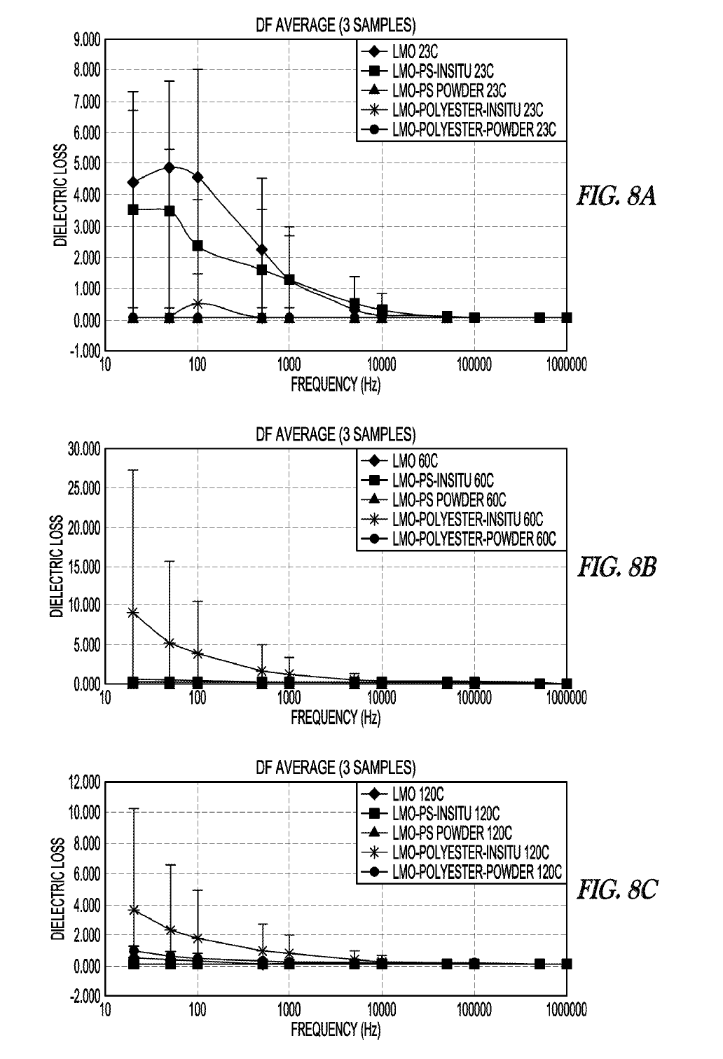

FIGS. 8a-8c show dielectric loss data for LMO with PS and polyester at 23, 60, and 120 degrees C. respectively.

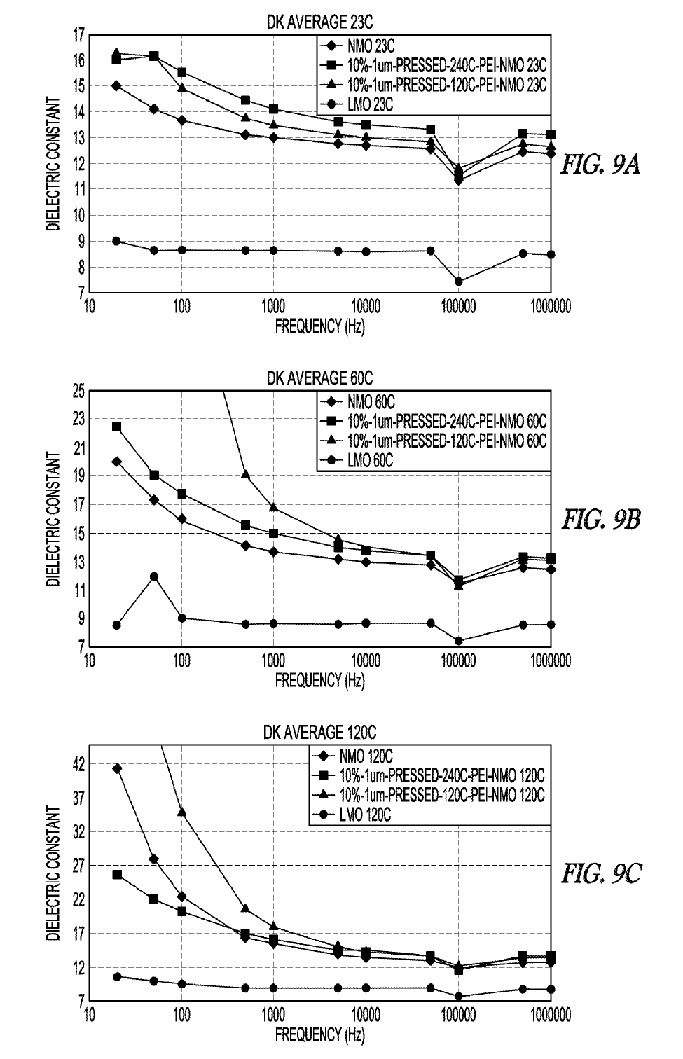

FIGS. 9a-9c show dielectric constant data for LMO and sodium molybdate (NMO) with polyetherimide (PEI) at 23, 60, and 120 degrees C. respectively.

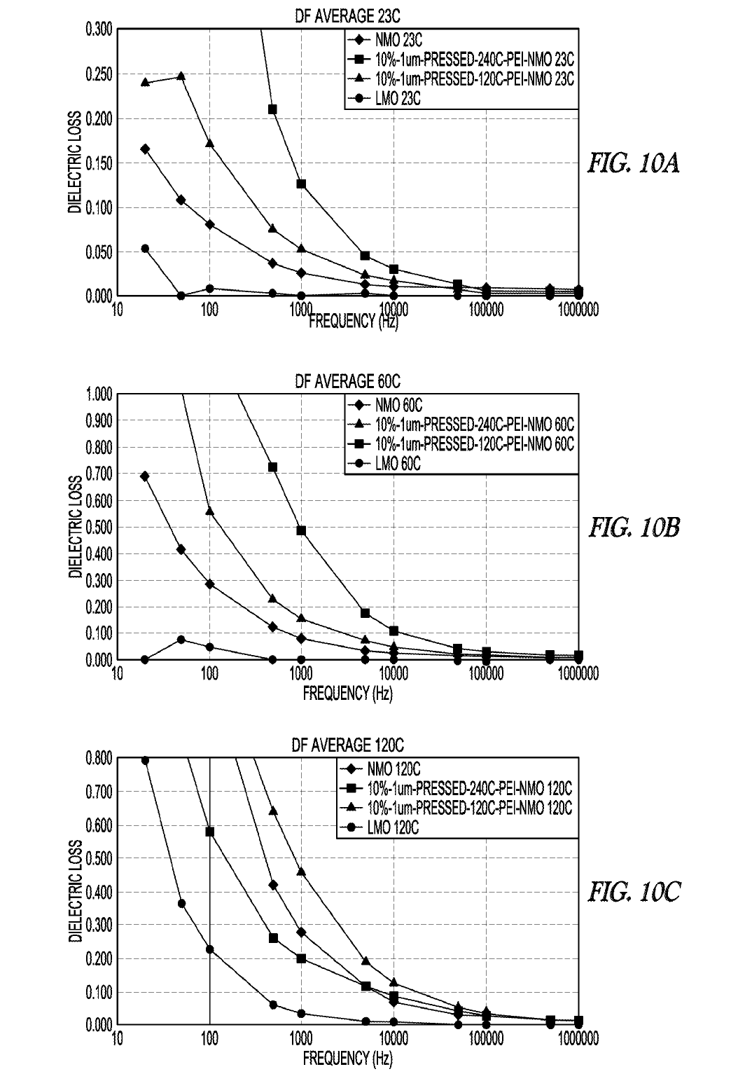

FIGS. 10a-10c show dielectric loss data for LMO and sodium molybdate (NMO) with polyetherimide (PEI) at 23, 60, and 120 degrees C. respectively.

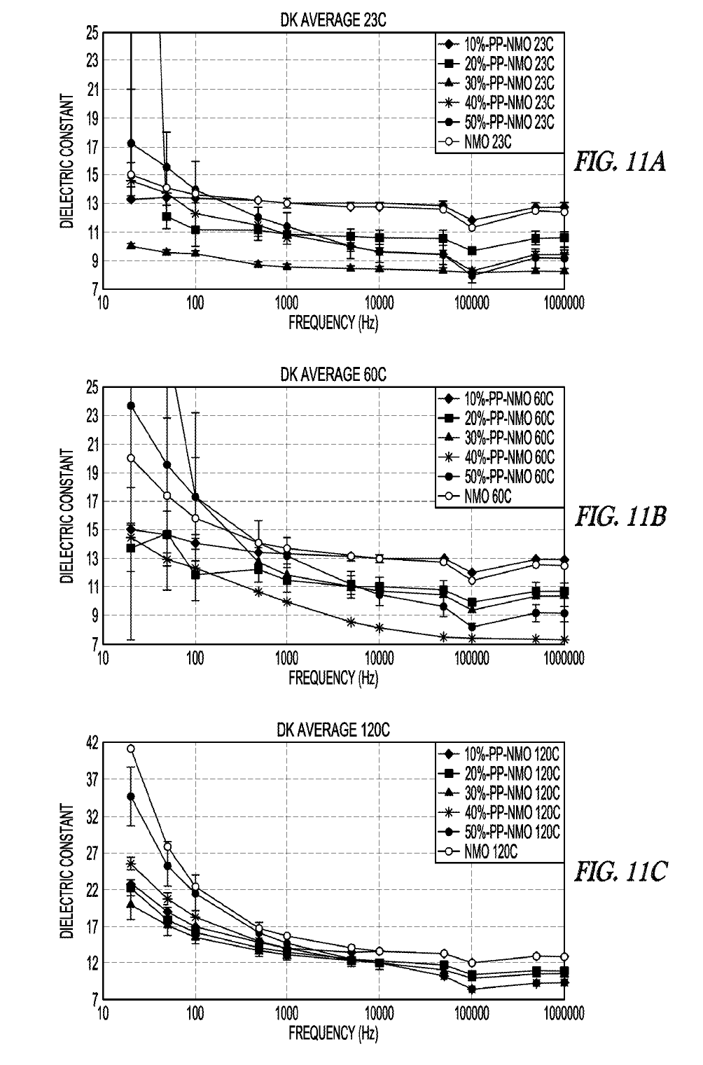

FIGS. 11a-11c show dielectric constant data for NMO with polypropylene (PP) at 23, 60, and 120 degrees C. respectively.

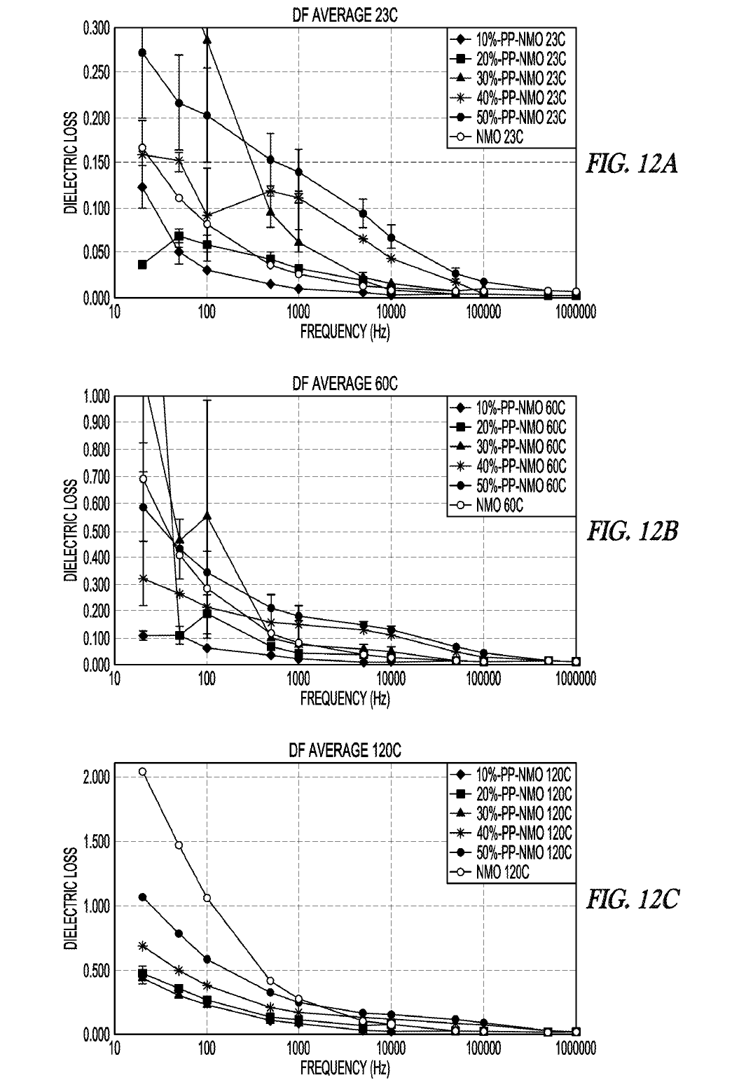

FIGS. 12a-12c show dielectric loss data for NMO with polypropylene (PP) at 23, 60, and 120 degrees C. respectively.

To better illustrate the method and apparatuses disclosed herein, a non-limiting list of embodiments is provided here:

Example 1 includes a capacitor. The capacitor includes a first electrode, and a second electrode. The capacitor includes a composite dielectric material located between the first electrode and the second electrode, wherein the composite dielectric material includes a cold sintered first phase component, and a self-healing polymer second phase component.

Example 2 includes the capacitor of example 1, wherein the self-healing polymer second phase component has a ratio of carbon to (hydrogen+oxygen) less than about 2.0.

Example 3 includes the capacitor of any one of examples 1-2, wherein the self-healing polymer second phase component has a ratio of carbon to (hydrogen+oxygen) less than about 1.5.

Example 4 includes the capacitor of any one of examples 1-3, wherein the self-healing polymer second phase component has a ratio of carbon to (hydrogen+oxygen) of approximately 0.5.

Example 5 includes the capacitor of any one of examples 1-4, wherein the self-healing polymer second phase component includes a semi-crystalline polymer.

Example 6 includes the capacitor of any one of examples 1-5, wherein the self-healing polymer second phase component includes an amorphous polymer.

Example 7 includes the capacitor of any one of examples 1-6, wherein the self-healing polymer second phase component includes a polyolefin.

Example 8 includes the capacitor of any one of examples 1-7, wherein the self-healing polymer second phase component includes polypropylene.

Example 9 includes the capacitor of any one of examples 1-8, wherein the self-healing polymer second phase component includes a fluorinated polymer.

Example 10 includes the capacitor of any one of examples 1-9, wherein the first and second electrode include multilayer plates at least partially interleaved with one another.

Example 11 includes the capacitor of any one of examples 1-10, wherein an amount of the dispersed phase dielectric compared to an amount of the sintered microstructure provides a modified coefficient of thermal expansion for the composite dielectric material that substantially matches a coefficient of thermal expansion for one or both of the first and second electrode.

Example 12 includes the capacitor of any one of examples 1-11, further including a hermetic seal encapsulant surrounding the first and second electrode and the composite dielectric material.

Example 13 includes the capacitor of any one of examples 1-12, wherein the hermetic seal encapsulant includes epoxy.

Example 14 includes a flexible capacitor. The flexible capacitor includes a first electrode, and a second electrode. The flexible capacitor includes a flexible composite dielectric material located between the first electrode and the second electrode, wherein the composite dielectric material includes, a cold sintered first phase component, and a self-healing polymer second phase component, wherein the self-healing polymer second phase component lowers the modulus of elasticity of the flexible composite dielectric material, wherein the first electrode, second electrode, and flexible composite dielectric material form a planar stack. The flexible capacitor includes a first end connection coupled to the first electrode and a second end connection coupled to the second electrode on two sides of the planar stack, wherein the planar stack is suspended between the first end connection and the second end connection, and allowed to flex.

Example 15 includes the flexible capacitor of example 14, wherein the first and second electrode include multilayer plates at least partially interleaved with one another.

Example 16 includes the flexible capacitor of any one of examples 14-15, wherein a flexible composite dielectric material thickness is approximately 0.5 microns per layer.

Example 17 includes the flexible capacitor of any one of examples 14-16, wherein the self-healing polymer second phase component includes polypropylene.

Example 18 includes the flexible capacitor of any one of examples 14-17, wherein the cold sintered first phase forms a matrix phase and the self-healing polymer second phase component forms a dispersed phase in the flexible composite dielectric material.

Example 19 includes the flexible capacitor of any one of examples 14-18, wherein the cold sintered first phase forms a dispersed phase and the self-healing polymer second phase component forms a matrix phase in the flexible composite dielectric material.

Example 20 includes a method of forming a capacitor. The method includes assembling an amount of a powder, including a cold sinterable ceramic powder and a polymer powder, applying an activating solvent to the amount of powder, applying sufficient heat and pressure to activate sintering of the powder below a destructive temperature of the polymer powder to form a cold sintered composite dielectric material, and locating the cold sintered composite dielectric material between at least two electrodes to form a capacitor.

Example 21 includes the method of example 20, wherein assembling an amount of a powder includes assembling an amount of a powder, including a cold sinterable ceramic powder and a self-healing polymer powder.

Example 22 includes the method of any one of examples 20-21, wherein the cold sintered composite dielectric material is formed while in contact with the at least two electrodes as a unit.

Example 23 includes the method of any one of examples 20-22, wherein applying sufficient heat and pressure includes applying heat above a glass transition temperature of the polymer.

Example 24 includes the method of any one of examples 20-23, wherein applying sufficient heat and pressure includes applying heat above a melting temperature of the polymer.

Example 25 includes the method of any one of examples 20-24, wherein applying an activating solvent to the amount of powder includes applying water to the amount of powder.

Example 26 includes the method of any one of examples 20-25, wherein applying an activating solvent to the amount of powder includes applying a solvent including alcohol to the amount of powder.

Example 27 includes a capacitor. The capacitor includes a first electrode, and a second electrode, wherein at least one of the electrodes includes copper, a composite dielectric material formed in place between the first electrode and the second electrode, while in contact with the first and second electrode, wherein the composite dielectric material includes, a cold sintered first phase component, and a self-healing polymer second phase component.

Example 28 includes a capacitor. The capacitor includes a first electrode, and a second electrode, wherein at least one of the electrodes includes aluminum, a composite dielectric material formed in place between the first electrode and the second electrode, while in contact with the first and second electrode, wherein the composite dielectric material includes, a cold sintered first phase component, and a self-healing polymer second phase component.

These and other examples and features of the present ceramic composite devices, materials, and related methods will be set forth in part in the above detailed description. This overview is intended to provide non-limiting examples of the present subject matter—it is not intended to provide an exclusive or exhaustive explanation.

While a number of advantages of embodiments described herein are listed above, the list is not exhaustive. Other advantages of embodiments described above will be apparent to one of ordinary skill in the art, having read the present disclosure. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

1. A capacitor, comprising:
a first electrode, and a second electrode;
a composite dielectric material located between the first electrode and the second electrode, wherein the composite dielectric material includes:
a cold sintered first phase component; and
a self-healing polymer second phase component.

2. The capacitor of claim 1, wherein the self-healing polymer second phase component has a ratio of carbon to (hydrogen+oxygen) less than about 2.0.

3. (canceled)

4. (canceled)

5. The capacitor of claim 1, wherein the self-healing polymer second phase component includes a semi-crystalline polymer or an amorphous polymer.

6. (canceled)

7. The capacitor of claim 1, wherein the self-healing polymer second phase component includes a polyolefin.

8. The capacitor of claim 1, wherein the self-healing polymer second phase component includes polypropylene.

9. The capacitor of claim 1, wherein the self-healing polymer second phase component includes a fluorinated polymer.

10. (canceled)

11. The capacitor of claim 1, wherein an amount of the dispersed phase dielectric compared to an amount of the sintered microstructure provides a modified coefficient of thermal expansion for the composite dielectric material that substantially matches a coefficient of thermal expansion for one or both of the first and second electrode.

12. The capacitor of claim 1, further including a hermetic seal encapsulant surrounding the first and second electrode and the composite dielectric material.

13. The capacitor of claim 12, wherein the hermetic seal encapsulant includes epoxy.

14. A flexible capacitor, comprising:
a first electrode, and a second electrode;
a fracture resistant composite dielectric material located between the first electrode and the second electrode, wherein the composite dielectric material includes:
a cold sintered first phase component;
a self-healing polymer second phase component, wherein the self-healing polymer second phase component lowers the modulus of elasticity of the fracture resistant composite dielectric material;
wherein the first electrode, second electrode, and flexible composite dielectric material form a planar stack; and
a first end connection coupled to the first electrode and a second end connection coupled to the second electrode on two sides of the planar stack, wherein the planar stack is suspended between the first end connection and the second end connection, and allowed to flex.

15. The flexible capacitor of claim 14, wherein the first and second electrode include multilayer plates at least partially interleaved with one another.

16. The flexible capacitor of claim 14, wherein a flexible composite dielectric material thickness is approximately 0.5 microns per layer.

17. The capacitor of claim 14, wherein the self-healing polymer second phase component includes polypropylene.

18. The capacitor of claim 14, wherein the cold sintered first phase forms a matrix phase and the self-healing polymer second phase component forms a dispersed phase in the flexible composite dielectric material.

19. The capacitor of claim 14, wherein the cold sintered first phase forms a dispersed phase and the self-healing polymer second phase component forms a matrix phase in the flexible composite dielectric material.

20. A method of forming a capacitor, comprising:
assembling an amount of a powder, including a cold sinterable ceramic powder and a polymer powder;
applying an activating solvent to the amount of powder;
applying sufficient heat and pressure to activate sintering of the powder below a destructive temperature of the polymer powder to form a cold sintered composite dielectric material; and
locating the cold sintered composite dielectric material between at least two electrodes to form a capacitor.

21. The method of claim 20, wherein assembling an amount of a powder includes assembling an amount of a powder, including a cold sinterable ceramic powder and a self-healing polymer powder.

22. The method of claim 20, wherein the cold sintered composite dielectric material is formed while in contact with the at least two electrodes as a unit.

23. The method of claim 20, wherein applying sufficient heat and pressure includes applying heat above a glass transition temperature of the polymer or applying heat above a melting temperature of the polymer.

24. (canceled)

25. The method of claim 20, wherein applying an activating solvent to the amount of powder includes applying water to the amount of powder or applying a solvent including alcohol to the amount of powder.

26. (canceled)

27. (canceled)

28. (canceled)
